(19) United States
(12) Patent Application Publication
(10) Pub. No.: US 2013/0170788 A1
(43) Pub. Date: Jul. 4, 2013

(54) OPTICAL FIBER CONNECTOR

(71) Applicant: YI-ZHONG SHEU, Tu-Cheng (TW)

(72) Inventor: YI-ZHONG SHEU, Tu-Cheng (TW)

(73) Assignee: HON HAI PRECISION INDUSTRY CO., LTD., Tu-Cheng (TW)

(21) Appl. No.: 13/437,019

(22) Filed: Apr. 2, 2012

(30) Foreign Application Priority Data
Dec. 30, 2011 (TW) 100149806

(51) Int. Cl. G02B 6/12; G02B 6/32

(52) U.S. Cl. 385/14; 385/33

(57) ABSTRACT

An optical fiber connector includes a substrate and an optical-electrical convertor. The substrate includes a loading surface and a sidewall. The loading surface defines a first and a second receiving grooves. The sidewall receives a first light channel passing through the sidewall and extending to the first receiving groove, and a second light channel passing through the sidewall and extending to the second receiving groove. The optical-electrical convertor includes a first coupling lens received in the first receiving groove, a second coupling lens received in the second receiving groove, a main body, a light emitting module, and a light receiving module. The main body has a top surface away from the substrate, and defines a first and a second through holes. The light emitting module and the light receiving module are positioned on the top surface, and are aligned with the first through hole and the second through hole respectively.

### BACKGROUND

1. Technical Field

The present disclosure relates to optical fiber connectors, and particularly, to an optical fiber connector which can be used as an optical signal emitting terminal or an optical signal receiving terminal.

2. Description of Related Art

An optical fiber connector may include a light emitting module, a light receiving module, a first reflector, a second reflector, a first light channel, and a second light channel. During assembly, the alignment of the first light channel with the first reflector, and the alignment of the second light channel with the second reflector requires an inordinate amount of time, therefore, the assembly efficiency of the optical fiber connector is reduced.

Therefore, it is desirable to provide an optical fiber connector that can overcome the above-mentioned limitations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic, exploded view of an optical fiber connector, according to an exemplary embodiment.

FIG. 2 is a schematic, assembled view of the optical fiber connector of FIG. 1.

FIG. 3 is a sectional view of the optical fiber connector of FIG. 2, taken along a line III-III.

### DETAILED DESCRIPTION

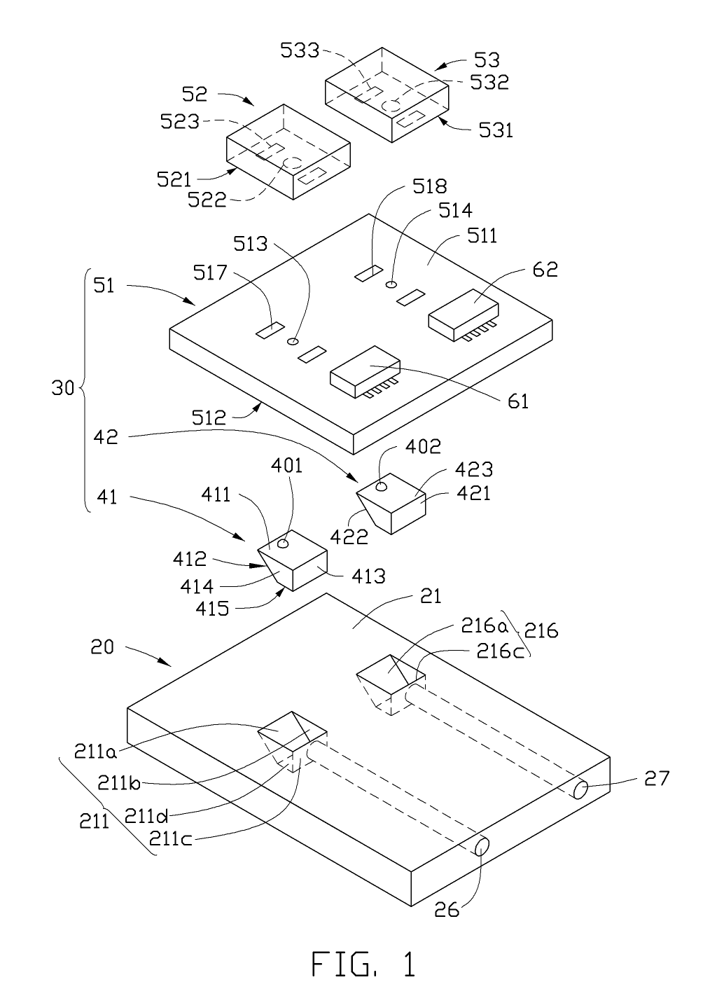

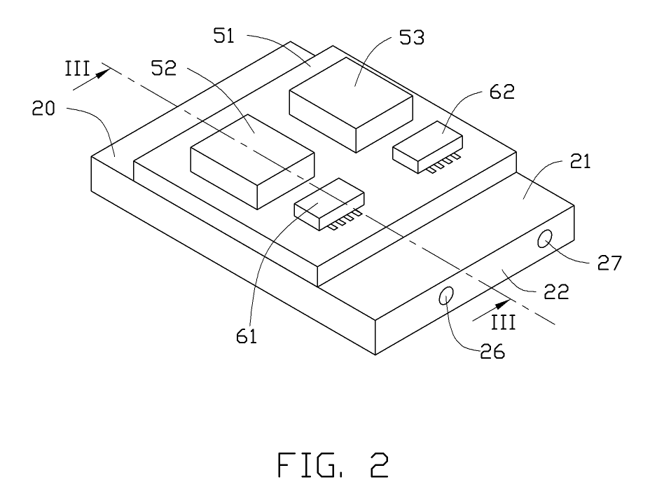

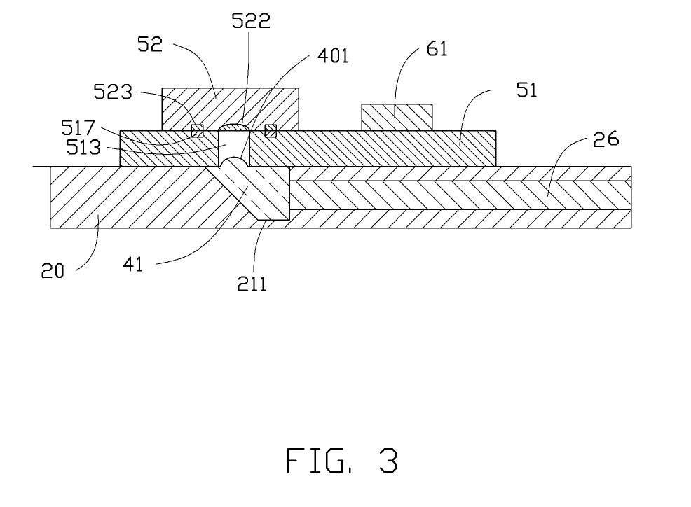

Referring to FIGS. 1-3, an optical fiber connector 100, according to an embodiment, includes a substrate 20, an optical-electrical module 30, a first chip 61, and a second chip 62.

The substrate 20 includes a loading surface 21 and a sidewall 22 perpendicular to the loading surface 21. The loading surface 21 defines a first receiving groove 211 and a second receiving groove 216. The first receiving groove 211 has a first inclined surface 211a, two opposite resisting surfaces 211b, a first connecting surface 211c opposite to the first inclined surface 211a, and a bottom surface 211d. The two resisting surfaces 211b are positioned on two opposite sides of the first inclined surface 211a. The bottom surface 211d is connected to the first inclined surface 211a, the two resisting surfaces 211b, and the first connecting surface 211c.

The configuration of the second receiving groove 216 is the same as the configuration of the first receiving groove 211. The second receiving groove 216 includes a second inclined surface 216a, and a second connecting surface 216c opposite to the second inclined surface 216a.

The substrate 20 receives a first optical channel 26 and a second optical channel 27 parallel to the first optical channel 26. The first optical channel 26 passes through the sidewall 22 and the first connecting surface 211c. The second optical channel 27 passes through the sidewall 22 and the second connecting surface 216c. The central axes of the first optical channel 26 and the second optical channel 27 are parallel to the loading surface 21.

The optical-electrical module 30 is positioned on the substrate 20, and includes a first coupling lens 41, a second coupling lens 42, a main body 51, a light emitting module 52, and a light receiving module 53.

The first coupling lens 41 includes a first optical surface 411, a first reflecting surface 412, a second optical surface 413 opposite to the first reflecting surface 412, two opposite trapezoidal surfaces 414, and a second bottom surface 415 opposite to the first optical surface 411. An included angle between the first reflecting surface 412 and the first optical surface 411 is about 45°. The two trapezoidal surfaces 414 are connected to the first reflecting surface 412 and the second optical surface 413. The shape of the first coupling lens 41 matches the shape of the first receiving groove 211, and thus the first coupling lens 41 can be exactly received in the first receiving groove 211. The first reflecting surface 412 contacts the first inclined surface 211a, the second optical surface 413 contacts the first connecting surface 211c, each of the two trapezoidal surfaces 414 contacts a resisting surface 211b, the second bottom surface 415 contacts the first bottom surface 211d. A first light converging portion 401 protrudes from the first optical surface 411.

The shape of the second coupling lens 42 is the same as the shape of the first coupling lens 41, and the second coupling lens 42 is exactly received in the second receiving groove 216. The second coupling lens 42 includes a third optical surface 421, a second reflecting surface 422, and a fourth optical surface 423. The second reflecting surface 422 contacts the second inclined surface 216a, the third optical surface 421 contacts the second connecting surface 216c. A second light converging portion 402 protrudes from the fourth optical surface 423.

The main body 51 is substantially cuboid, and is fixed on the substrate 20. The main body 51 includes a top surface 511 away from the substrate 20, and a bottom surface 512 opposite to the top surface 511. The main body 51 defines a first through hole 513 and a second through hole 514, both of which pass through the top surface 511 and the bottom surface 512. The first through hole 513 is aligned with the first light converging portion 401, the second through hole 514 is aligned with the second light converging portion 402, and thus, the first light converging portion 401 is received in one end of the first through hole 513 adjacent to the bottom surface 512, the second light converging portion 402 is received in one end of the second through hole 514 adjacent to the bottom surface 512. Two first pads 517 and two second pads 518 are positioned on the top surface 511. The first through hole 513 is positioned between the two first pads 517, and the second through hole 514 is positioned between the two second pads 518.

The light emitting module 52 and the light receiving module 53 are positioned on the top surface 511. The light emitting module 52 is used for converting a first electrical signal into a first optical signal, and has a first surface 521 facing the top surface 511. The first surface 521 has a light emitting portion 522 aligned with the first through hole 513, and two third pads 523 aligned with the two first pads 517. The light emitting portion 522 faces the first through hole 513, and is used for emitting the first optical signal. The light emitting portion 522 may be a laser diode. The first electrical signal may be current signal.

The light receiving module 53 is used for receiving a second optical signal from another optical fiber connector (not shown), and converting the second optical signal into a second electrical signal. The light receiving module 53 includes a second surface 531 facing the top surface 511. A light receiving portion 532 is positioned on the second surface 531, aligned with the second through hole 514, and two fourth pads 533 corresponding to the two second pads 518. The light receiving portion 532 faces the second through hole 514, and is used for receiving the second optical signal. The light receiving portion 532 may be an photo diode. The second electrical signal may be current signal.

The first chip 61 and the second chip 62 are positioned on the main body 51. The first chip 61 is electrically connected to the first pads 517, and the second chip 62 is electrically connected to the second pads 518. The first chip 61 is used for providing the first electrical signal to the light emitting module 52. The second chip 62 is used for converting the second electrical signal from the light receiving module 53 to a third electrical signal. The third electrical signal may be voltage signal.

The first optical channel 26 is used for transmitting the first optical signal, and the second optical channel 27 is used for transmitting the second optical signal. In this embodiment, each of the first optical channel 26 and the second optical channel 27 is an optical fiber.

In assembly, the first coupling lens 41 and the second coupling lens 42 are received in the first receiving groove 211 and the second receiving groove 216 respectively. The first light converging portion 401 and the second light converging portion 402 are received in the first through hole 513 and the second through hole 514 respectively, and then the main body 51 is fixed on the substrate 20. The light emitting portion 522 is aligned with the first through hole 513, and the light receiving portion 532 is aligned with the second through hole 514. The two first pads 517 are soldered onto the two third pads 523; the two second pads 518 are soldered onto the two fourth pads 533. Thus, the alignment of the first coupling lens 41 with the light emitting portion 523 and the first optical channel 26 is rendered simple, fast and reliable, as is the alignment of the second coupling lens 42 with the light receiving portion 532 and the second optical channel 27, thus the overall assembly efficiency of the optical fiber connector 100 is improved.

In use, when the optical fiber connector 100 is used as an optical signal emitting terminal, the light emitting module 52 converts the first electrical signal from the first chip 61 to the first optical signal. The first optical signal is emitted from the light emitting portion 522, then is converged by the first light converging portion 401, finally, the first optical signal is reflected by the first reflecting surface 412 to enter into the first optical channel 26, the first optical channel 26 transmits the first optical signal to another optical fiber connector (not shown).

When the optical fiber connector 100 is used as an optical signal receiving terminal, the second optical channel 27 receives the second optical signal from the another optical fiber connector (not shown), and the second optical signal is reflected by the second reflecting surface 422 to enter into the second light converging portion 402. Finally, the light receiving portion 532 receives the second optical signal, and converts the second optical signal into the second electrical signal, the second chip 62 receives the second electrical signal, and converts the second electrical signal into the third electrical signal.

In another embodiment, the second light converging portion 402 also can be positioned on the third optical surface 421.

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An optical fiber connector, comprising:
a substrate comprising:
a loading surface defining a first receiving groove and a second receiving groove; and
a sidewall connecting to the loading surface;
wherein the substrate receives a first light channel passing through the sidewall and extending to the first receiving groove, and a second light channel passing through the sidewall and extending to the second receiving groove; and
a main body positioned on the loading surface, the main body having a top surface away from the loading surface and a bottom surface opposite to the top surface, the main body defining a first through hole and a second through hole passing through the top surface and the bottom surface; a first coupling lens received in the first receiving groove, and having a first light converging portion received in one end of the first through hole adjacent to the bottom surface; a second coupling lens received in the second receiving groove, and having a second light converging portion received in one end of the second through hole adjacent to the bottom surface; a light emitting module positioned on the top surface, and having a light emitting portion aligned with the first through hole; and a light receiving module positioned on the top surface, and having a light receiving portion aligned with the second through hole.

2. The optical fiber connector of claim 1, wherein the top surface positions two first pads and two second pads, the light emitting module has a first surface facing the top surface, the light emitting portion is positioned on the first surface, the first surface further positions two third pads, each third pad touches a respective one of the two first pads, the light receiving module has a second surface facing the top surface, the light receiving portion is positioned on the second surface, the second surface further positions two fourth pads, each fourth pad touches a respective one of the two second pads.

3. The optical fiber connector of claim 2, wherein the light emitting portion is positioned between the two third pads, and the light receiving portion is positioned between the two fourth pads.

4. The optical fiber connector of claim 1, wherein the shape of the first receiving groove is a fit with the shape of the first coupling lens, and the shape of the second receiving groove is a fit with the shape of the second coupling lens.

5. The optical fiber connector of claim 1, wherein an extending direction of each of the first light channel and the second light channel is parallel to the loading surface, the first coupling lens has a first reflecting surface optically aligned with the first optical channel and the first light converging portion, and an included angle between the first reflecting surface and the loading surface is 45°, the second coupling lens has a second reflecting surface optically aligned with the second optical channel and the second light converging portion, and an included angle between the second reflecting surface and the loading surface is 45°.

6. The optical fiber connector of claim 5, wherein the configuration of the first receiving groove is the same as the configuration of the second receiving groove, and the configuration of the first coupling lens is the same as the configuration of the second coupling lens.

7. The optical fiber connector of claim 6, wherein the first receiving groove comprises a first inclined surface, a first connecting surface opposite to the first inclined surface, and two opposite resisting surfaces, the two resisting surfaces are connected to the first inclined surface and the first connecting surface, the first light channel passes through the first connecting surface, the first coupling lens further comprises a first optical surface, a second optical surface, and two opposite trapezoidal surfaces, the first converging portion protrudes from the first optical surface, the second optical surface is perpendicular to the first optical surface, the two trapezoidal surfaces connect to the first reflecting surface and the second optical surface, the first reflecting surface contacts with the first inclined surface, the second optical surface contacts with the first connecting surface, each of the two trapezoidal surfaces contacts with a corresponding resisting surface.

8. The optical fiber connector of claim 6, wherein the second coupling lens further comprises a third optical surface facing, and a fourth optical surface perpendicular to the third optical surface, the second converging portion protrudes from the fourth optical surface.

9. The optical fiber connector of claim 1, wherein each of the first light channel and the second light channel is an optical fiber.

10. The optical fiber connector of claim 1, further comprising a first chip and a second chip, the first chip and the second chip being positioned on the top surface, the first chip being electrically connected to the light emitting module, and being configured for providing a first electrical signal to the light emitting module, the second chip being electrically connected to the light receiving module, and being configured for converting a second electrical signal from the light receiving module to a third electrical signal.

11. The optical fiber connector of claim 10, wherein the first electrical signal and the second electrical signal are current signals, and the third electrical signal is voltage signal.
